(19) United States
(12) Patent Application Publication
(10) Pub. No.: US 2021/0390158 A1
(43) Pub. Date: Dec. 16, 2021

(54) UNSUPERVISED MODEL ADAPTATION APPARATUS, METHOD, AND PROGRAM

(71) Applicant: NEC Corporation, Minato-ku, Tokyo (JP)

(72) Inventors: Kong Aik LEE, Tokyo (JP); Qiongqiong WANG, Tokyo (JP); Takafumi KOSHINAKA, Tokyo (JP)

(73) Assignee: NEC Corporation, Minato-ku, Tokyo (JP)

(21) Appl. No.: 17/284,899

(22) PCT Filed: Mar. 28, 2019
(86) PCT No.: PCT/JP2019/013618

§ 371 Date: Apr. 13, 2021

(30) Foreign Application Priority Data
Oct. 25, 2018 (JP) PCT/JP2018/039613

(51) Int. Cl. G06F 17/16; G06N 20/00; G06K 9/62

(52) U.S. Cl. CPC G06F 17/16; G06K 9/623; G06K 9/6234; G06N 20/00

(57) ABSTRACT

A covariance matrix computation unit 81 computes a pseudo-in-domain covariance matrix from one or both of a within class covariance matrix and a between class covariance matrix of an out-of-domain Probabilistic Linear Discriminant Analysis (PLDA) model. A simultaneous diagonalization unit 82 computes a generalized eigenvalue and an eigenvector for a pseudo-in-domain covariance matrix and the class covariance matrix of the out-of-domain PLDA model on the basis of simultaneous diagonalization. An adaptation unit 83 computes one or both of a within class covariance matrix and a between class covariance matrix of an in-domain PLDA model using the generalized eigenvalues and eigenvectors. The covariance matrix computation unit 81 computes the pseudo-in-domain covariance matrix based on the out-of-domain PLDA model and a covariance matrix of in-domain data.

### TECHNICAL FIELD

The present invention relates to an unsupervised model adaptation apparatus, an unsupervised model adaptation method, and an unsupervised model adaptation program for adapting a model using unlabelled data.

### BACKGROUND ART

The conditions at the time of development (Train) are different from the conditions at the time of use (Test). For example, in most practical applications, the condition under which a speaker recognition system was developed differs from those in which we use the system. Such form of mismatch between the Train and Test (e.g., language difference) is referred to as domain mismatch.

In order to solve the domain mismatch, re-training using in-domain data may be performed in some cases. In-domain data could be collected, usually limited in terms of quantity and without labels, to minimize the cost of deployment. Re-training of the system (model) is therefore prohibited as much larger amount of labelled data is required. Therefore, it can be said that unsupervised adaptation of backend classifier (e.g., probabilistic linear discriminant analysis) is needed.

NPL 1 and NPL 2 describes a probabilistic linear discriminant analysis (PLDA) backend. The PLDA backend performs channel compensation and serves as a scoring backend. PLDA models the distribution of speaker embedding vectors (e.g., i-vector, x-vector) as a Gaussian distribution with explicit modeling of the within and between class variability as separate matrices.

On the other hand, domain adaptation that applies knowledge obtained from source domain to target domain is also known. NPL 3 and NPL 4 describes a correlation alignment (CORAL) as a method of domain adaptation. In the method described in NPL 3 and NPL 4, domain adaptation is accomplished with a two-step procedure, that is, whitening followed by re-coloring. Also, domain adaptation is performed on features, i.e., speaker embedding vector (e.g., i-vector and x-vector).

Also, the PLDA using Student's t-distribution instead of Gaussian distribution is known as a Heavy-Tailed PLDA (HT-PLDA). NPL 5 describes fast variational Bayes for HL-PLDA applied to i-vectors and x-vectors. NPL 6 describes a method in which Bayesian speaker verification with Heavy-Tailed Priors.

### CITATION LIST

### Non Patent Literature

[NPL 1]
S. Ioffe, “Probabilistic linear discriminant analysis,” ECCV 2006, Part IV, LNCS 3954, pp. 531-542, 2006
[NPL 2]
S. J. D. Prince and J. H. Elder, “Probabilistic linear discriminant analysis for inferences about identity,” in Proc. ICCV, 2007, pp. 1-8.
[NPL 3]
B. Sun, J. Feng, and K. Saenko, “Return of frustratingly easy domain adaptation,” in Proc. AAAI, 2016, vol. 6, p. 8.
[NPL 4]
J. Alam, G Bhattacharya, P. Kenny, “Speaker verification in mismatched conditions with frustratingly easy domain adaptation,” in Proc. Odyssey, 2018, pp. 176-180.
[NPL 5]
A. Silnova, N. Brummer, D. Garcia-Romero, D. Snyder, L. Burget, “Fast variational bayes for heavy-tailed PLDA applied to i-vectors and x-vectors”, Interspeech 2018
[NPL 6]
P. Kenny, “Bayesian speaker verification with heavy-tailed priors”, Odyssey 2010

### SUMMARY OF INVENTION

### Technical Problem

However, within class covariance matrix and between class covariance matrix do not match well the distribution when applied in the field due to domain mismatch. Additionally, it is costly to re-train PLDA as described in NPL1 and NPL2 to match the domain of various applications, and large amount of labelled dataset is required.

Moreover, CORAL as described in NPL3 and NPL4 is a feature domain adaptation technique. Domain adaptation is performed by transforming out-of-domain data which are labelled. Backend classifier is then trained using the domain adapted data. However, when using CORAL described in NPL3 and NPL4, the backend classifier is re-trained by keeping the entire out-of-domain dataset and transforming them to in-domain when needed. Therefore, it costs a lot of storage and computation.

FIG. 13 depicts an exemplary explanatory diagram illustrating a feature-based CORAL adaptation followed by PLDA re-training. In the following explanation, when using a Greek letter in the text, an English notation of Greek letter may be enclosed in brackets ([ ]). In addition, when representing an upper case Greek letter, the beginning of the word in [ ] is indicated by capital letters, and when representing lower case Greek letters, the beginning of the word in [ ] is indicated by lower case letters. The [Phi]′_{w} indicates a within class convariance matrix of the adapted PLDA model. The [Phi]′_{b} indicates a between class convariance matrix of the adapted PLDA model. X_{OOD} indicates out-of-domain train data, and Y_{OOD} indicates labels of train data. X_{InD} indicates in-domain unlabeled train data and T_{InD} indicates test data.

In CORAL 110, X′_{OOD} is computed from X_{OOD} and X_{InD}. Specifically, when C₁=cov(X_{InD}) and C_{O}=cov(X_{OOD}) are defined, then X′_{OOD} is computed as X′_{OOD}=C_{I}^{1/2} C_{O}^{-1/2} X_{OOD}. In Train PLDA 120, {[Phi]′_{w}, [Phi]′_{b}} is learned with domain-adapted data X′_{OOD} and Y_{OOD}. Then, in PLDA Backend 130, when test data T_{InD} is input, the score is computed.

FIG. 14 depicts a flowchart illustrating the CORAL algorithm for unsupervised adaptation of out-of-domain data followed by PLDA training. The notation shown in FIG. 14 is the same as that shown in FIG. 13. Out-of domain data {X_{OOD}, Y_{OOD}} and in-domain data X_{InD} are input (step S101). The emprical covariance matrix C_{I} is estimated from in-domain data X_{InD} (step S102). Similarly, the emprical covariance matrix C_{O} is estimated from out-of-domain data X_{OOD} (step S103).

The out-of domain data is adapted to in-domain and X′_{OOD} is computed (step S104). By training PLDA using X′_{OOD} and Y_{OOD}, {[Phi]′_{w,0}, [Phi]′_{b,0}} is computed (step S105). Then, the adapted covariance matrices {[Phi]′_{w}, [Phi]′_{b}} are output (step S106).

As shown in FIG. 13 and FIG. 14, since it is necessary to keep the entire out-of-domain dataset X_{OOD}, there is a problem that cost for maintaining dataset to re-train is expensive.

It is an exemplary object of the present invention to provide an unsupervised model adaptation apparatus, an unsupervised model adaptation method, and an unsupervised model adaptation program, when a model trained based on out-of-domain dataset is adapted to an in-domain model using unlabelled data, which can perform an unsupervised model adaptation while reducing the cost of adaptation.

### Solution to Problem

An unsupervised model adaptation apparatus according to the present invention includes: a covariance matrix computation unit which computes a pseudo-in-domain covariance matrix from one or both of a within class covariance matrix and a between class covariance matrix of an out-of-domain Probabilistic Linear Discriminant Analysis (PLDA) model, a simultaneous diagonalization unit which computes a generalized eigenvalue and an eigenvector for a pseudo-in-domain covariance matrix and the class covariance matrix of the out-of-domain PLDA model on the basis of simultaneous diagonalization, and an adaptation unit which computes one or both of a within class covariance matrix and a between class covariance matrix of a pseudo-in-domain PLDA model using the generalized eigenvalues and eigenvectors; wherein the covariance matrix computation unit computes the pseudo-in-domain covariance matrix based on the out-of-domain PLDA model and a covariance matrix of in-domain data.

An unsupervised model adaptation method according to the present invention includes: computing a pseudo-in-domain covariance matrix from one or both of a within class covariance matrix and a between class covariance matrix of an out-of-domain Probabilistic Linear Discriminant Analysis (PLDA) model, computing a generalized eigenvalue and an eigenvector for a pseudo-in-domain covariance matrix and the class covariance matrix of the out-of-domain PLDA model on the basis of simultaneous diagonalization, and computing one or both of a within class covariance matrix and a between class covariance matrix of a pseudo-in-domain PLDA model using the generalized eigenvalues and eigenvectors; wherein the pseudo-in-domain covariance matrix is computed based on the out-of-domain PLDA model and a covariance matrix of in-domain data.

An unsupervised model adaptation program according to the present invention causes a computer to perform: a covariance matrix computation process of computing a pseudo-in-domain covariance matrix from one or both of a within class covariance matrix and a between class covariance matrix of an out-of-domain Probabilistic Linear Discriminant Analysis (PLDA) model; a simultaneous diagonalization process of computing a generalized eigenvalue and an eigenvector for a pseudo-in-domain covariance matrix and the class covariance matrix of the out-of-domain PLDA model on the basis of simultaneous diagonalization; and an adaptation process of computing one or both of a within class covariance matrix and a between class covariance matrix of a pseudo-in-domain PLDA model using the generalized eigenvalues and eigenvectors; wherein in the covariance matrix computation process, the pseudo-in-domain covariance matrix is computed based on the out-of-domain PLDA model and a covariance matrix of in-domain data.

### Advantageous Effects of Invention

According to the present invention, when a model trained based on out-of-domain dataset is adapted to an in-domain model using unlabelled data, it is possible to perform an unsupervised model adaptation while reducing the cost of adaptation.

### BRIEF DESCRIPTION OF DRAWINGS

FIG. 1

It depicts an exemplary block diagram illustrating the structure of a first exemplary embodiment of an unsupervised model adaptation apparatus according to the present invention.

FIG. 2

It depicts an exemplary explanatory diagram illustrating the structure of the first exemplary embodiment of the unsupervised model adaptation apparatus according to the present invention.

FIG. 3

It depicts a flowchart illustrating an operation example of the unsupervised model adaptation apparatus 100 according to the first exemplary embodiment.

FIG. 4

It depicts a flowchart illustrating an operation example of the model adaptation unit 30 according to the first exemplary embodiment.

FIG. 5

It depicts a flowchart illustrating another operation example of the model adaptation unit 30 according to the first exemplary embodiment.

FIG. 6

It depicts an exemplary block diagram illustrating the structure of the second exemplary embodiment of an unsupervised model adaptation apparatus according to the present invention.

FIG. 7

It depicts an exemplary explanatory diagram illustrating the structure of the second exemplary embodiment of the unsupervised model adaptation apparatus according to the present invention.

FIG. 8

It depicts a flowchart illustrating an operation example of the unsupervised model adaptation apparatus 200 according to the second exemplary embodiment.

FIG. 9

It depicts a flowchart illustrating an operation example of the model adaptation unit 240 according to the second exemplary embodiment.

FIG. 10

It depicts a flowchart illustrating another operation example of the model adaptation unit 240 according to the second exemplary embodiment.

FIG. 11

It depicts a block diagram illustrating an outline of the unsupervised model adaptation apparatus according to the present invention.

FIG. 12

It depicts a schematic block diagram illustrating the configuration example of the computer according to the exemplary embodiment of the present invention.

FIG. 13

It depicts an exemplary explanatory diagram illustrating a feature-based CORAL adaptation followed by PLDA adaptation.

FIG. 14

It depicts a flowchart illustrating the CORAL algorithm for unsupervised adaptation of out-of-domain data followed by PLDA training.

### DESCRIPTION OF EMBODIMENTS

The following describes an exemplary embodiment of the present invention with reference to drawings.

### Exemplary Embodiment 1

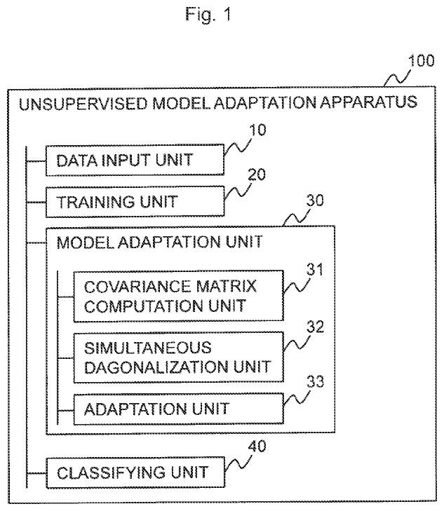

FIG. 1 depicts an exemplary block diagram illustrating the structure of a first exemplary embodiment of an unsupervised model adaptation apparatus according to the present invention.

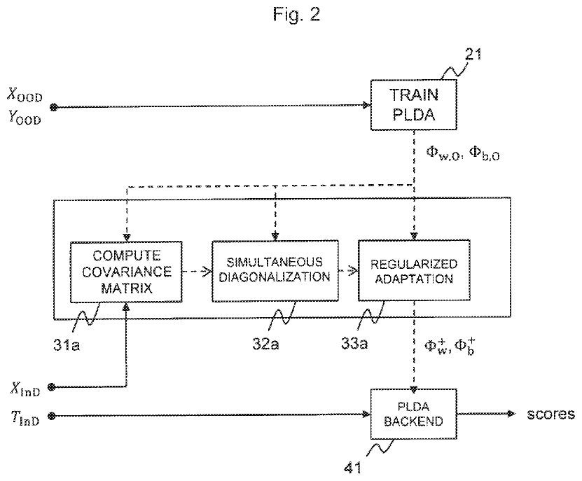

FIG. 2 depicts an exemplary explanatory diagram illustrating the structure of the first exemplary embodiment of the unsupervised model adaptation apparatus according to the present invention. The unsupervised model adaptation apparatus 100 according to the present exemplary embodiment includes a data input unit 10, a training unit 20, a model adaptation unit 30, and a classifying unit 40.

The data input unit 10 inputs out-of-domain data X_{OOD} and labels Y_{OOD} as training data of the training unit 20. For example, the data input unit 10 may acquire data via an communication network from an external storage device (not shown) that stores previously collected training data and input the acquired data to the training unit 20.

The training unit 20 learns an out-of-domain PLDA model (See 21 of FIG. 2). Then the training unit 20 computes within class covariance matrix [Phi]_{w,0} and between class covariance matrix [Phi]_{b,0} (hereinafter, a combination of [Phi]_{w,0} and [Phi]_{b,0} may be referred to as within and between class covariance matrices) from the out-of-domain PLDA model. That is, [Phi]_{w,0} and [Phi]_{b,0} are out-of-domain within and between class covariance matrices computed from the PLDA model. The method by which the training unit 20 learns the out-of-domain PLDA model and computes the within and between class covariance matrices is the same as the method described in NPL 1 or NPL 2.

The model adaptation unit 30 includes a covariance matrix computation unit 31, a simultaneous dagonalization unit 32, and an adaptation unit 33.

The covariance matrix computation unit 31 computes a pseudo-in-domain covariance matrix S from within class covariance matrix [Phi]_{w,0}, between class covariance matrix [Phi]_{b,0}, the covariance matrix C_{I} estimated from in-domain data X_{InD}, and an out-of-domain covariance matrix C_{O} (See 31a of FIG. 2). The out-of-domain covariance matrix C_{O} is computed using the out-of-domain PLDA model.

Note that the covariance matrix computation unit 31 may compute the pseudo-in-domain covariance matrix S from either within class covariance matrix [Phi]_{w,0} or between class covariance matrix [Phi]_{b,0}, or from both within class covariance matrix [Phi]_{w,0} and between class covariance matrix [Phi]_{b,0}. Computation using both [Phi]_{w,0} and [Phi]_{b,0} is more preferable because accuracy can be improved. If only one of [Phi]_{w,0} and [Phi]_{b,0} is used, then [Phi]⁺_{w} or [Phi]⁺_{b} is computed. If both [Phi]_{w,0} and [Phi]_{b,0} are used, then [Phi]⁺_{w} and [Phi]⁺_{b} is computed. The covariance matrix computation unit 31 may compute the pseudo-in-domain covariance matrix S as shown in equation 1 below.

[Math. 1]

S=C_{I}^{1/2}C_{O}^{-1/2}ΦC_{O}^{-1/2}C_{I}^{1/2} (Equation 1)

The simultaneous dagonalization unit 32 computes a generalized eigenvalue and an eigenvector {B, E} for the pseudo-in-domain matrix S and the covariance matrices [Phi] of the out-of-domain PLDA on the basis of simultaneous diagonalization (See 32a of FIG. 2). Specifically, the simultaneous dagonalization unit 32 finds the generalized eigenvalue and the eigenvector {B, E} based on the following equation 2. In equation 2, EVD(.) returns a matrix of an eigenvector and the corresponding eigenvalue in a diagonal matrix.

[Math. 2]

{Q,Λ}←EVD(Φ)

{P,E}←EVD(Λ^{-1/2}Q^{T}SQΛ^{-1/2})

B=QΛ^{-1/2}P (Equation 2)

That is, the simultaneous dagonalization unit 32 computes the matrix of an eigenvector Q and an eigenvalue [Lambda] based on the covariance matrices [Phi], and computes the matrix of an eigenvector P and an eigenvalue E based on the the pseudo-in-domain matrix S, the eigenvector Q, and the eigenvalue [Lambda]. Then the simultaneous dagonalization unit 32 computes the eigenvalue B based on the eigenvector Q, the eigenvalue [Lambda] and the eigenvector P.

The adaptation unit 33 computes within and between class covariance matrices {[Phi]⁺_{w}, [Phi]⁺_{b}} using the eigenvalue B and eigenvector E. Since the within and between class covariance matrices to be calculated is generated from the pseudo-in-domain covariance matrix, it can be said to be the within and between class covariance matrices of the pseudo-in-domain PLDA model.

Note that the adaptation unit 33 may compute either within class covariance matrix [Phi]⁺_{w} or between class covariance matrix [Phi]⁺_{b}, both within class covariance matrix [Phi]_{w,0} and the between class covariance matrix [Phi]_{b,0}. The adaptation unit 33 may compute within and between class covariance matrices [Phi]⁺ as shown in equation 3 below.

[Math. 3]

Φ_{w}⁺=Φ_{w,0}+γB_{w}^{-T}(E_{w}−I)B_{w}⁻¹

Φ_{b}⁺=Φ_{b,0}+βB_{b}^{-T}(E_{b}−I)B_{b}⁻¹ (Equation 3)

In equation 3, [gamma] and [beta] in equation 3 are hyper parameters (adaptation parameters) constrained to be n the range [0, 1]. B_{w} is a transformation matrix such that B^{T}_{w}[Phi]_{w,0}B_{w}=I, and B^{T}_{w}SB_{w}=E_{w} where E_{w} is a diagonal matrix. Similarly, B_{b} is a transformation matrix such that B^{T}_{b}[Phi]_{b,0}B_{b}=I, and B^{T}_{b}SB_{b}=E_{b} where E_{b} is a diagonal matrix. [Phi]⁺_{w} and [Phi]⁺_{b} are adapted within and between class covariance matrices.

Note that in order to avoid shrinking of the within and between class covariance matrices, the adaptation unit 33 may compute within and between class covariance matrices [Phi]⁺ as shown in equation 4 below.

[Math. 4]

Φ_{w}⁺=Φ_{w,0}+γB_{w}^{-T} max(0,E_{w}−I)B_{w}⁻¹

Φ_{b}⁺=Φ_{b,0}+βB_{b}^{-T} max(0,E_{b}−I)B_{b}⁻¹ (Equation 4)

That is, the adaptation unit 33 may performs a regularization process which avoid shrinking of the within and between class covariance. The adaptation unit 33 outputs the adapted within and between class covariance matrices (See 33a of FIG. 2).

The classifying unit 40 computes a score for the test data T_{inD} based on the adapted within and between class covariance matrices output from the model adaptation unit 30 (See 41 of FIG. 2). The method of classifying using the score is the same as the method described in NPL 1 or NPL 2.

As mentioned above, according to the present exemplary embodiment, the unsupervised model adaptation apparatus 100 performs integration of a feature-based domain adaptation method (e.g. CORAL) to PLDA model leading to a model-based adaptation. It is caused regularized adaptation to ensure that variances (i.e., uncertainty) of the PLDA model increases after adaptation.

The data input unit 10, the training unit 20, the model adaptation unit 30 (more specifically, the covariance matrix computation unit 31, the simultaneous dagonalization unit 32, and the adaptation unit 33), and a classifying unit 40 are each implemented by a CPU of a computer that operates in accordance with a program (unsupervised model adaptation program). For example, the program may be stored in a storage unit (not shown) included in the unsupervised model adaptation apparatus 100, and the CPU may read the program and operate as the data input unit 10, the training unit 20, the model adaptation unit 30 (more specifically, the covariance matrix computation unit 31, the simultaneous dagonalization unit 32, and the adaptation unit 33), and a classifying unit 40 in accordance with the program.

In the unsupervised model adaptation apparatus 100 of the exemplary present embodiment, the data input unit 10, the training unit 20, the model adaptation unit 30 (more specifically, the covariance matrix computation unit 31, the simultaneous dagonalization unit 32, and the adaptation unit 33), and a classifying unit 40 may each be implemented by dedicated hardware. Further, the unsupervised model adaptation apparatus according to the present invention may be configured with two or more physically separate devices which are connected in a wired or wireless manner.

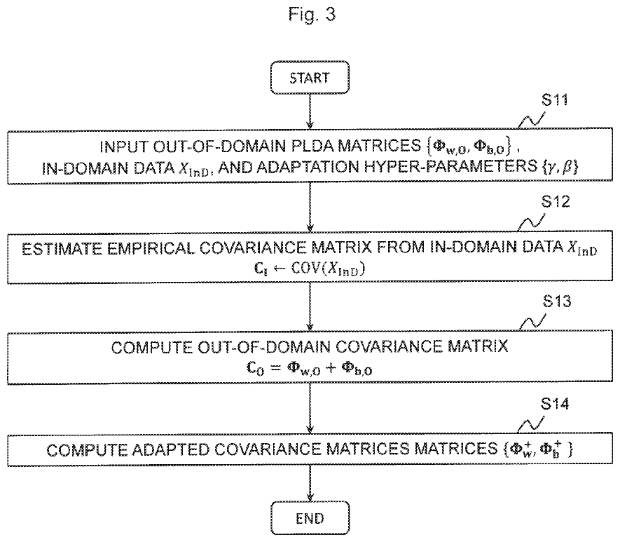

Next, operation of the unsupervised model adaptation apparatus according to the present exemplary embodiment will be described. FIG. 3 depicts a flowchart illustrating an operation example of the unsupervised model adaptation apparatus 100 according to the first exemplary embodiment.

The data input unit 10 inputs the out-of-domain PLDA matrices {[Phi]_{w,0}, [Phi]_{b,0}}, in-domain data X_{InD} and Adaptation hyper-parameters {[gamma], [beta]} (step S11). The training unit 20 estimates empirical covariance matrix C_{I} from in-domain data X_{InD} (step S12). The model adaptation unit 30 computes out-of-domain covariance matrix (step S13). The model adaptation unit 30 computes adapted covariance matrices {[Phi]⁺_{w}, [Phi]⁺_{b}} and output them (step S14).

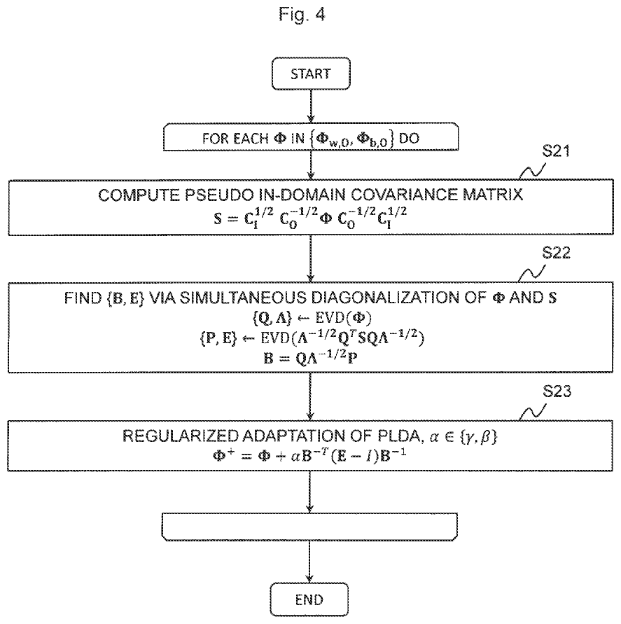

FIG. 4 depicts a flowchart illustrating an operation example of the model adaptation unit 30 according to the first exemplary embodiment. For each [Phi] in {[Phi]_{w,0}, [Phi]_{b,0}}, the following steps S21 to S23 are performed.

The covariance matrix computation unit 31 computes the pseudo-in-domain covariance matrix S (step S21). The simultaneous dagonalization unit 32 computes generalized eigenvalues and eigenvectors for a pseudo-in-domain covariance matrix and the class covariance matrix of the out-of-domain PLDA model on the basis of simultaneous diagonalization (step S22). That is, The simultaneous dagonalization unit 32 find generalized eigenvalues and eigenvectors via simultaneous diagonalization of [Phi] and S. The adaptation unit 33 computes an adaptation unit computes within and between class covariance matrices of a pseudo-in-domain PLDA model using the generalized eigenvalues and eigenvectors (step S23). That is, the adaptation unit 33 performs regularized adapation of PLDA. In FIG. 4, [alpha] depicts a hyper parameter included in the input adaptation hyper-parameters {[gamma], [beta]}.

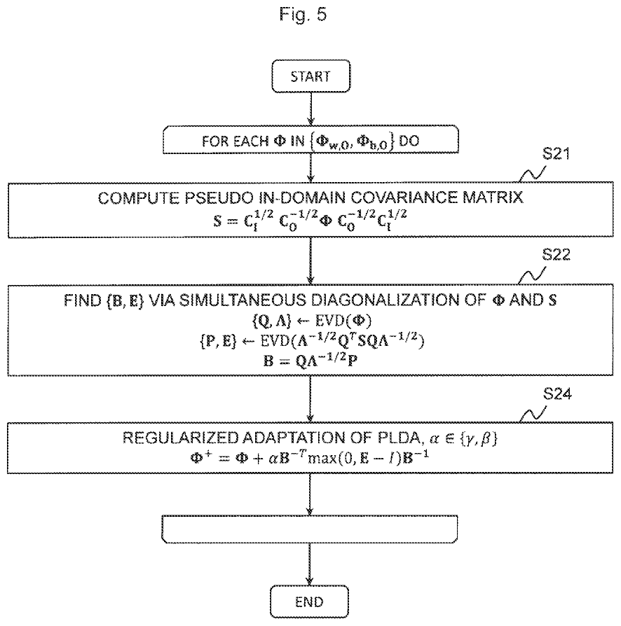

FIG. 5 depicts a flowchart illustrating another operation example of the model adaptation unit 30 according to the exemplary embodiment. The flowchart illustrated in FIG. 5 shows an example of operation in the case where the regularization process is performed. The process in step S21 and step S22 are the same as the process shown in FIG. 4.

In step S24, the adaptation unit 33 performs the regularization process which avoid shrinking of the within and between class covariance matrix. In FIG. 5, the process of computing the term including “max” indicates the regularization process.

In this manner, in the present exemplary embodiment, the covariance matrix computation unit 31 computes a pseudo-in-domain covariance matrix S from one or both of [Phi]_{w,0} and [Phi]_{b,0}. The simultaneous dagonalization unit 32 computes a simultaneous diagonalization a generalized eigenvalue and an eigenvector for the S and [Phi] on the basis of simultaneous diagonalization. The adaptation unit 33 computes one or both of [Phi]⁺_{w} and [Phi]⁺_{b} of a pseudo-in-domain PLDA model using the generalized eigenvalues and eigenvectors. Moreover, the covariance matrix computation unit 31 computes the S based on the out-of-domain PLDA model (C_{O}) and a covariance matrix of in-domain data (C_{I}).

With the above structure, when a model trained based on out-of-domain dataset is applied to an in-domain model using unsupervised data, it is possible to perform an unsupervised model adaptation while reducing the cost of adaptation.

That is, according to the present exemplary embodiment, an unsupervised adaptation is applied by transforming the within and between class covariance matrices. Moreover, a transformation matrix is computed using the unlabeled in-domain data and the parameter of the out-of-domain classifier. Therefore, the original out-of-domain data is not required, which saves the computation and storage requirement of the system.

### Exemplary Embodiment 2

PLDA, as mentioned so far, models the distribution of speaker embedding vectors (e.g., i-vector, x-vector) as a Gaussian distribution. Such PLDA is referred to as generative PLDA (G-PLDA). There is another type called heavy-tailed PLDA (HT-PLDA) which models the distribution of speaker embedding vectors as a form of Student's t-distribution. In the real world, data is more like Student's t-distribution rather than Gaussian distribution. Therefore, HT-PLDA matches to real data better than G-PLDA, and is expected to have better performance on such real-world data.

As mentioned in Background Art, since the conditions (often referred to as a “domain”) at the time of development are often different from the conditions at the time of use of the developed system, domain adaptation is commonly applied to compensate the difference. However, because of complex formulation of HT-PLDA, none of domain adaptation methods has been invented, which limits the usage of HT-PLDA, regardless its advantage of matching to real data.

NPL5 and NPL6 show in HT-PLDA, speaker embedding vectors (e.g., i-vector, x-vector) rⱼ which is element of R^{D} is produced by projection of hidden speaker identity variables zᵢ which is element of R^{d} into the D-dimensional space with D-by-d factor loading matrix F:

[Math. 5]

rⱼ=Fzᵢ+ηⱼ [Math. 5]

Here [eta]ⱼ denotes noise which is independently drawn from a heavy-tailed distribution as follows:

$${η}_{j} ∼ N ( 0 , {( \frac{{λ}_{j}}{v} W )}^{- 1} ) \qquad [ Math . 6 ]$$

where [lambda]ⱼ is sampled from the Chi-squared distribution, [lambda]ⱼ˜[Chi]_{[nu]}², parametrized by [nu], known as the degrees of freedom; the expectation value of the precision modulation factor is <[lambda]/[nu]>=1; W is D-by-D positive definite. Marginalizaing out the hidden [lambda]ⱼ, given a speaker identity vector zᵢ, the probability is a t-distribution:

$$P ( r \vert {z}_{i} ) = 𝒯 ( r \vert F {z}_{i} , W , v ) ∝ {[ 1 + \frac{{( r - F {z}_{i} )}^{′} W ( r - F {z}_{i} )}{v} ]}^{\frac{v + D}{2}} , \qquad [ Math . 7 ]$$

and posterior is

[Math. 8]

[symbol]

(z|\hat{z}ᵢⱼ,Hᵢⱼ,ν′)∂P(r|zᵢ), [Math. 8]

where

$${\hat{z}}_{i j} = {H}_{i j}^{- 1} {a}_{i j} , {H}_{i j} = {b}_{i j} {H}_{0} , {a}_{i j} = {b}_{i j} {F}^{′} W {r}_{ij} , \\ {b}_{i j} = \frac{v + D - d}{v + {r}_{i j}^{T} G {Γ}_{l j}} , {H}_{0} = {F}^{′} W F , G = W - W F {H}_{0}^{- 1} {F}^{′} W . \qquad [ Math . 9 ]$$

G is a projection operator onto the orthogonal complement of the speaker subspace, i.e. GF=0. HT-PLDA has parameters (F,W,[nu]).

FF^{T} and bᵢⱼ⁻¹H₀⁻¹ can be considered as between-speaker covariance and within-speaker covariance in HT-PLDA.

[Phi]_{b}=FF^{T}

[Phi]_{w}=bᵢⱼ⁻¹H₀⁻¹ (Equation 5)

Therefore, the present invention can be applied to HT-PLDA as it is to adapt between-speaker and within-speaker covaricances. For [Phi] in ([Phi]_{b}, [Phi]_{w}), the pseudo-in-domain covariance matrix is modified for HT-PLDA:

$${S}_{i j} = {C}_{I}^{\frac{1}{2}} {C}_{O , ij}^{- \frac{1}{2}} {ΦC}_{O , ij}^{- \frac{1}{2}} {C}_{I}^{\frac{1}{2}} , \qquad [ Math . 10 ]$$

where C_{I} is calculated from unlabelled in-domain data, and C_{O,ij}=FF^{T}+bᵢⱼ⁻¹H₀⁻¹. Then we can get adapted between-speaker covariance:

$$\begin{matrix} {Φ}_{b , ij}^{+} = {Φ}_{b , O} + β {B}_{b , i j}^{- T} ( {E}_{b , i j} - I ) {B}_{b , ij}^{- 1} , \\ where & [ Math . 11 ] \\ {B}_{b , i j} = {Q}_{b , i j} {Λ}_{b}^{- \frac{1}{2}} {P}_{b , ij} , \\ \{ {P}_{b , ij} , {E}_{b , i j} \} ← EVD ( {Λ}_{b}^{- \frac{1}{2}} {Q}_{b}^{T} {S}_{i j} {Q}_{b} {Λ}_{b}^{- \frac{1}{2}} ) , \{ {Q}_{b} , {Λ}_{b} \} ← EVD ( {Φ}_{b} ) , & [ Math . 12 ]\end{matrix}$$

and adapted within-speaker covariance:

$$\begin{matrix} {Φ}_{w , i j}^{+} = {Φ}_{w , O . ij} + γ {B}_{w , ij}^{- T} ( {E}_{w , ij} - I ) {B}_{w , ij}^{- 1} , \\ where & [ Math . 13 ] \\ {B}_{w , i j} = {Q}_{w , i j} {Λ}_{w , i j}^{- \frac{1}{2}} {P}_{w , ij} , \\ \{ {P}_{w , ij} , {E}_{w , i j} \} ← EVD ( {Λ}_{w , ij}^{- \frac{1}{2}} {Q}_{w , ij} {}_{}^{T}{S}{}_{i j}^{} {Q}_{w , i j} {Λ}_{w , ij}^{- \frac{1}{2}} ) , \{ {Q}_{w , ij} , {Λ}_{w , ij} \} ← EVD ( {Φ}_{w , i j} ) . & [ Math . 14 ]\end{matrix}$$

Since within-speaker covariance in HT-PLDA is not constant but a variable dependent on two parameters (W, [nu]) and hence dependent on individual speaker embedding vectors r, adaptation parameters are also variables. There is no analytic solution to the adaptation equations.

Thus, the present invention proposes an assumption to solve the problem. It is assumed that bᵢⱼ⁻¹ and H₀⁻¹ in [Phi]_{w} are decomposable. With the assumption, the adaptation is equivalent to the adaptation of [Phi]′_{b}=FF^{T} and [Phi]′_{w}=W⁻¹ (Equation 6):

$$\begin{matrix} {Φ}^{′ +} = {Φ}_{O} + β {B}^{- T} ( E - I ) {B}^{- 1} , \\ where & [ Math . 15 ] \\ B = Q {Λ}^{- \frac{1}{2}} P , \{ P , E \} ← E V D ( {Λ}^{- \frac{1}{2}} {Q}^{T} {S}^{′} Q {Λ}^{- \frac{1}{2}} ) , \{ Q , Λ \} ← EVD ( {Φ}^{′} ) , \\ {S}^{′} = {C}_{I}^{\frac{1}{2}} {( {C}^{′} )}_{O}^{- \frac{1}{2}} {Φ}^{{{′C}^{′}}_{O}^{- \frac{1}{2}} {C}_{I}^{\frac{1}{2}}} , {C}^{′} = {Φ}_{b}^{′} + {Φ}_{w}^{′} . & [ Math . 16 ]\end{matrix}$$

This adaptation equations have analytic solutions. After ([Phi]′_{b}⁺, [Phi]′_{w}⁺) are obtained, (F⁺,W⁺) are calculated to replace the OOD HT-PLDA. In addition, the third parameter [nu] can be kept the same or adapted by fitting a gamma distribution to the unlabeled in-domain data.

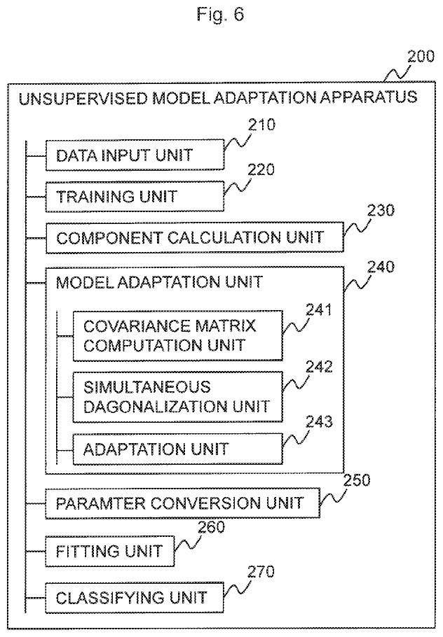

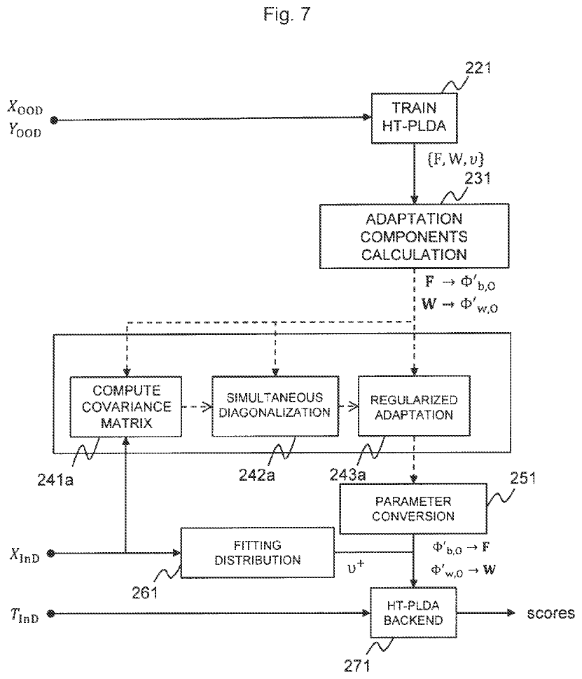

FIG. 6 depicts an exemplary block diagram illustrating the structure of a second exemplary embodiment of an unsupervised model adaptation apparatus according to the present invention. FIG. 7 depicts an exemplary explanatory diagram illustrating the structure of the second exemplary embodiment of the unsupervised model adaptation apparatus according to the present invention. The unsupervised model adaptation apparatus 200 according to the present exemplary embodiment includes a data input unit 210, a training unit 220, a component calculation unit 230, a model adaptation unit 240, a parameter conversion unit 250, a fitting unit 260, and a classifying unit 270.

The data input unit 210 inputs out-of-domain data X_{OOD} and labels Y_{OOD} as training data of the HT-PLDA training unit 220. For example, the data input unit 210 may acquire data via an communication network from an external storage device (not shown) that stores previously collected training data and input the acquired data to the training unit 220.

The training unit 220 learns an out-of-domain HT-PLDA model (See 221 of FIG. 7: the training unit 220 trains HT-PLDA). Then the training unit 220 computes factor loading matrix F, precision matrix W, and degrees of freedom [nu] as the parameters of the out-of-domain HT-PLDA model. The method by which the training unit 220 learns the out-of-domain HT-PLDA model and computes {F, W, [nu]} is the same as the method described in NPL 5 or NPL 6.

The component calculation unit 230 calculates the covariance components {[Phi]′_{b,O}, [Phi]′_{w,O}} from two parameters {F,W} of the out-of-domain HT-PLDA model: [Phi]′_{b,O}=FF^{T}, [Phi]′_{w,O}=W⁻¹. The present invention assumes equation 5 can be decomposed into two components and adapting those components independently is equivalent to adapting the parameters of HT-PLDA (See 231 of FIG. 7). [Phi]′_{b,O} and [Phi]′_{w,O} are referred to as out-of-domain between and within class covariance components in this document to clarify the difference from the definition of between and within class covariances.

The model adaptation unit 240 includes a covariance matrix computation unit 241, a simultaneous dagonalization unit 242, and an adaptation unit 243, same as the first exemplary embodiment. But it adapts the between and within class covariance components as mentioned in the above instead of the covariances.

The covariance matrix computation unit 241 computes a pseudo-in-domain covariance matrix S′ from a within class covariance component [Phi]′_{w,O}, a between class covariance component [Phi]′_{b,O}, the covariance matrix C_{I} estimated from in-domain data X_{InD}, and an out-of-domain covariance component (See 241a of FIG. 7). The out-of-domain covariance component C′_{O} is computed using the out-of-domain HT-PLDA model.

Note that the covariance matrix computation unit 241 may compute the pseudo-in-domain covariance matrix S from either the within class covariance component [Phi]′_{w,O} or the between class covariance component [Phi]′_{b,O}, or from both the within class covariance component [Phi]′_{w,O} and the between class covariance component [Phi]′_{b,O}. Computation using both [Phi]′_{w,O} and [Phi]′_{b,O} is more preferable because accuracy can be improved. If only either of [Phi]′_{w,O} or [Phi]′_{b,O} is used, then C′_{O} is [Phi]′_{w,O} or [Phi]′_{b,O}. If both [Phi]′_{w,O} and [Phi]′_{b,O} are used, then C′_{O} is the sum of [Phi]′_{w,O} and [Phi]′_{b,O}. The covariance matrix computation unit 241 may compute the pseudo-in-domain covariance matrix S′ as shown in equation 7 below.

$$[ Math . 17 ]$$

$${S}^{′} = {C}_{I}^{\frac{1}{2}} {{C}^{′}}_{O}^{- \frac{1}{2}} {Φ}^{′} {{C}^{′}}_{O}^{- \frac{1}{2}} {C}_{I}^{\frac{1}{2}} \qquad ( Equation 7 )$$

where C′_{O} is either of [Phi]′_{w,O}, [Phi]′_{b,O}, or [Phi]′_{w,O}+[Phi]′_{b,O}.

The simultaneous dagonalization unit 242 computes the generalized eigenvalues and eigenvectors {B, E} for the pseudo-in-domain matrix S′ and the covariance component [Phi]′ of the out-of-domain HT-PLDA on the basis of simultaneous diagonalization (See 242a of FIG. 7). Specifically, the simultaneous dagonalization unit 242 finds the generalized eigenvalues and the eigenvectors {B, E} based on the following equation 8. In equation 8, EVD(.) is a function that returns a matrix of eigenvectors and the corresponding eigenvalues in a diagonal matrix.

$$[ Math . 18 ]$$

$$\{ Q , Λ \} ← EVD ( {Φ}^{′} ) , \\ \{ P , E \} ← ( {Λ}^{- \frac{1}{2}} {Q}^{T} {S}^{′} Q {Λ}^{- \frac{1}{2}} ) \\ B = Q {Λ}^{- \frac{1}{2}} P . \qquad ( Equation 8 )$$

That is, the simultaneous dagonalization unit 242 computes the matrix of eigenvectors Q and eigenvalues [lambda] based on the covariance component [Phi]′, and computes the matrix of eigenvectors P and eigenvalues E based on the the pseudo-in-domain matrix S, the eigenvector Q, and the eigenvalue [Lambda]. Then the simultaneous dagonalization unit 242 computes the eigenvalue B based on the eigenvector Q, the eigenvalue [Lambda] and the eigenvector P.

The adaptation unit 243 computes within and between class covariance components {[Phi]′_{w}⁺, [Phi]′_{b}⁺} using the eigenvalue B and eigenvector E. Since the within and between class covariance components to be calculated is generated from the pseudo-in-domain covariance matrix, it can be said to be the within and between class covariance components of the pseudo-in-domain PLDA model.

Note that the adaptation unit 243 may compute either the within class covariance component [Phi]′_{w}⁺ or the between class covariance components [Phi]′_{b}⁺, both the within class covariance matrix [Phi]′_{w}⁺ and the between class covariance matrix [Phi]′_{b}⁺. The adaptation unit 243 may compute within and between class covariance matrices [Phi]′⁺ as shown in equation 9 below.

[Math. 19]

Φ′_{w}⁺=Φ_{w,O}+γB_{w}^{-T}(E_{w}−I)B_{w}⁻¹,

Φ′_{b}⁺=Φ_{b,O}+βB_{b}^{-T}(E_{b}−I)B_{b}⁻¹. (Equation 9)

In equation 9, [gamma] and [beta] are hyper-parameters (adaptation parameters) constrained to be in the range [0, 1]. B_{w} is a transformation matrix such that B_{w}^{T}[Phi]′_{w,O}B_{w}=I, and B_{w}^{T}S_{w}B_{w}=E_{w}, where E_{w} is a diagonal matrix. Similarly, B_{b} is a transformation matrix such that B_{b}^{T}[Phi]′_{b,O}B_{b}=I, and B_{b}^{T}S_{b}B_{b}=E_{b}, where E_{b} is a diagonal matrix. [Phi]′_{w}⁺ and [Phi]′_{b}⁺ are the adapted within and between class covariance components.

Note that in order to avoid shrinking of the within and between class covariance components, the adaptation unit 243 may compute within and between class covariance components [Phi]′⁺ as shown in equation 10 below.

[Math. 20]

Φ′_{w}⁺=Φ_{w,O}+γB_{w}^{-T} max(0,E_{w}−I)B_{w}⁻¹,

Φ′_{b}⁺=φ_{b,O}+βB₁^{-T} max(0,E_{b}−I)B_{b}⁻¹. (Equation 10)

That is, the adaptation unit 243 may perform a regularization process which avoid shrinking of the within and between class covariance. The adaptation unit 243 outputs the adapted within and between class covariance components (See 243a of FIG. 7).

The parameter conversion unit 250 computes adapted factor loading matrix F and precision matrix W (See equation 6) from the adapated within and between class covariance components {[Phi]′_{b}⁺, [Phi]′_{w}⁺ } (See 251 of FIG. 7).

The fitting unit 260 fits a Student's t-distribution to the unlabeled in-domain data, and fixes the degree of freedom [nu]⁺ for the adapted HT-PLDA model (See 261 of FIG. 7). There are some tools which can estimate parameter [nu] by fitting a Student's t-distribution to data.

The classifying unit 270 computes a score for the test data T_{inD} based on the adapted actor loading matrix F⁺ and precision matrix W⁺ from the output of parameter conversion unit 250, and the degree of freedom [nu]⁺ from fitting unit 260 (See 271 of FIG. 7). The method of classification using the score is the same as the method described in NPL 5 or NPL 6.

As mentioned above, according to the present exemplary embodiment, the unsupervised model adaptation apparatus 200 performs integration of a feature-based domain adaptation method (e.g. CORAL) to HT-PLDA model leading to a model-based adaptation. It is caused regularized adaptation to ensure that variances (i.e., uncertainty) of the HT-PLDA model increases after adaptation.

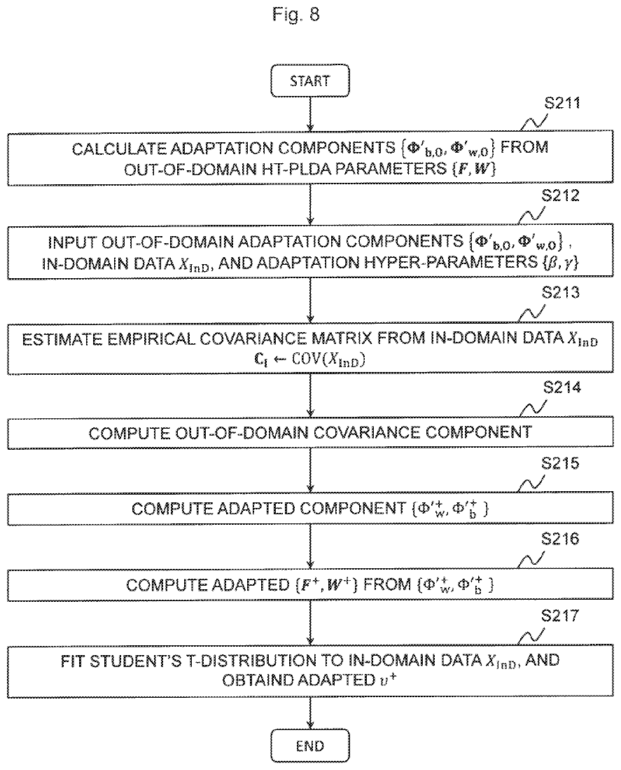

Next, operation of the unsupervised model adaptation apparatus according to the present exemplary embodiment will be described. FIG. 8 depicts a flowchart illustrating an operation example of the unsupervised model adaptation apparatus 200 according to the second exemplary embodiment.

The data input unit 210 inputs out-of-domain data X_{OOD} and labels Y_{OOD} as training data of the HT-PLDA training unit 220. The training unit 220 learns an out-of-domain HT-PLDA model {F, W, [nu]}. Then the component calculation unit 230 calculates the components {[Phi]′_{b,O}), [Phi]′_{w,O}} from two parameters {F,W} (step S211). The data input unit 210 inputs the out-of-domain adaptation components {[Phi]′_{b,O}), [Phi]′_{w,O}}, in-domain data X_{InD} and adaptation hyper-parameters {[beta], [gamma]} (step S212). The training unit 220 estimates empirical covariance matrix C_{I} from in-domain data X_{InD} (step S213). The model adaptation unit 240 computes out-of-domain covariance components (step S214). The model adaptation unit 240 computes adapted covariance components {[Phi]′_{w}⁺), [Phi]′_{b}⁺} (step S215).

The parameter conversion unit 250 computes adapted factor loading matrix F⁺ and precision matrix W⁺ from the adapated within and between class covariance components {[Phi]′_{b}⁺, [Phi]′_{w}⁺ } (step S216) and outputs them. The fitting unit 260 fits a Student's t-distribution to the unlabeled in-domain data, updates the degree of freedom [nu]⁺ for the adapted HT-PLDA model, and outputs it (step S217).

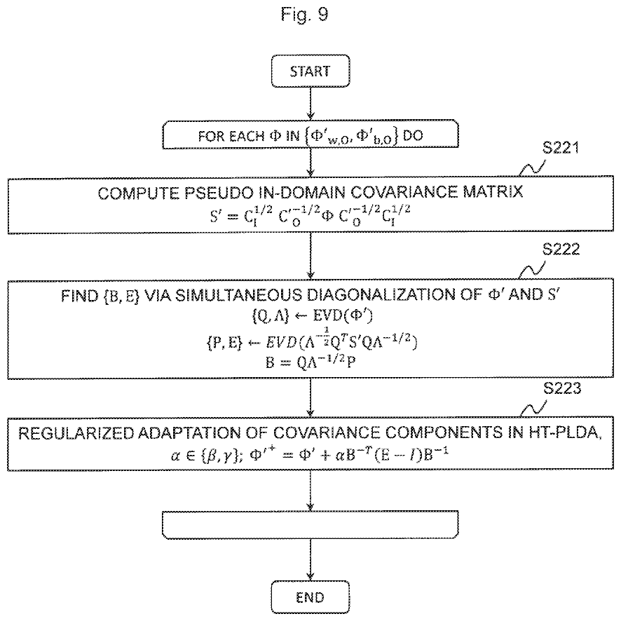

FIG. 9 depicts a flowchart illustrating an operation example of the model adaptation unit 240 according to the second exemplary embodiment. For each [Phi]′ in {[Phi]′_{w,O}, [Phi]′_{b,O}}, the following steps S221 to S223 are performed.

The covariance matrix computation unit 241 computes the pseudo-in-domain covariance matrix S′ (step S221). The simultaneous dagonalization unit 242 computes generalized eigenvalues B and eigenvectors E for a pseudo-in-domain covariance matrix and the between and within class covariance components of the out-of-domain HT-PLDA model on the basis of simultaneous diagonalization (step S222). That is, the simultaneous dagonalization unit 242 finds generalized eigenvalues B and eigenvectors E via simultaneous diagonalization of [Phi]′ and S′. The adaptation unit 243 computes within and between class covariance components of a pseudo-in-domain PLDA model using the generalized eigenvalues and eigenvectors (step S223). That is, the adaptation unit 243 performs regularized adapation of covariance components in HT-PLDA. In FIG. 9, [alpha] depicts a hyper-parameter included in the input adaptation hyper-parameters {[beta], [gamma]}.

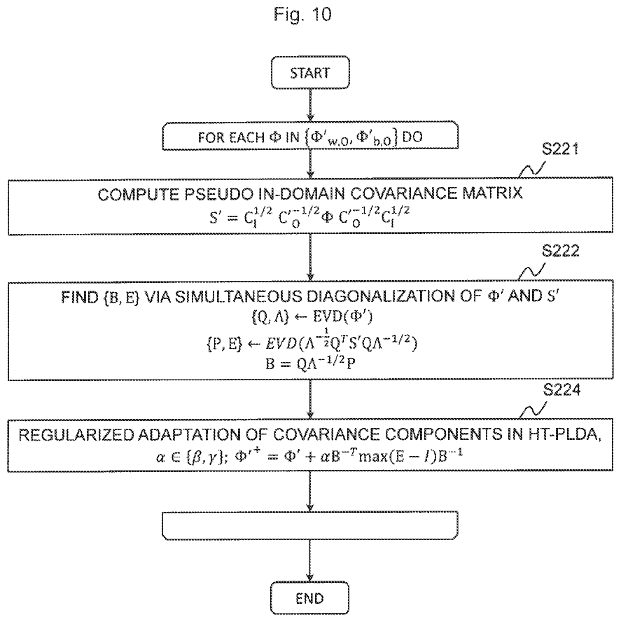

FIG. 10 depicts a flowchart illustrating another operation example of the model adaptation unit 240 according to the second exemplary embodiment. The flowchart illustrated in FIG. 10 shows an example of operation in the case where the regularization process is performed. The process in step S221 and step S222 are the same as the process shown in FIG. 9.

In step S224, the adaptation unit 243 performs the regularization process which avoids shrinking of the within and between class covariance components. In FIG. 10, the process of computing the term including “max” indicates the regularization process.

In this manner, in the second exemplary embodiment, the covariance matrix computation unit 241 computes a pseudo-in-domain covariance matrix S from one or both of [Phi]′_{w,O} and [Phi]′_{b,O}. The simultaneous dagonalization unit 242 computes a simultaneous diagonalization a generalized eigenvalues and eigenvectors for the S and [Phi]′. The adaptation unit 243 computes one or both of [Phi]′_{w,O}⁺ and [Phi]′_{b,O}⁺ of covariance components in a pseudo-in-domain HT-PLDA model using the generalized eigenvalues and eigenvectors. Moreover, the covariance matrix computation unit 241 computes the S based on the out-of-domain PLDA model (C′_{O}) and a covariance matrix of in-domain data (C_{I}).

With the above structure, when a model trained on the basis of out-of-domain data is applied to an in-domain model using unsupervised data, it is possible to perform an unsupervised model adaptation to HT-PLDA.

That is, according to the present exemplary embodiment, an unsupervised adaptation is applied by transforming in an approximate manner the within and between class covariance matrices made up with the original HT-PLDA parameters. Moreover, a transformation matrix is computed using the unlabeled in-domain data and the parameter of the out-of-domain classifier. Therefore, the original out-of-domain data is not required, which saves the computation and storage requirement of the system. In addition, the heavy-tailed modeling makes it possible to achieve even higher accuracy than using generative PLDA.

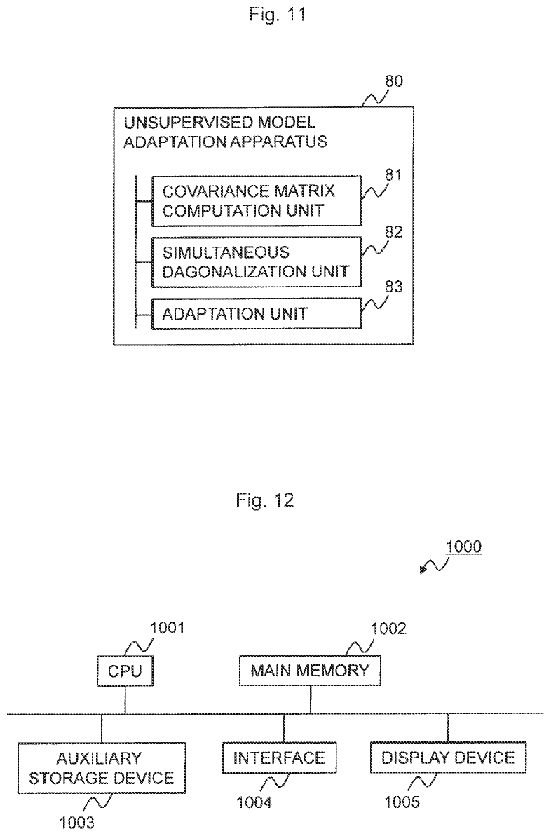

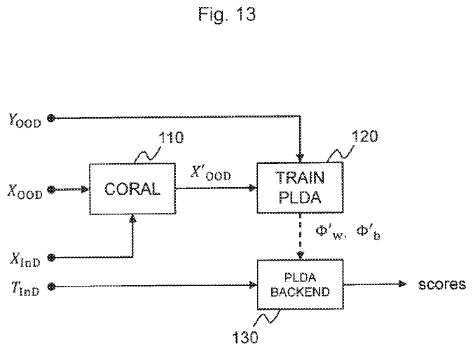

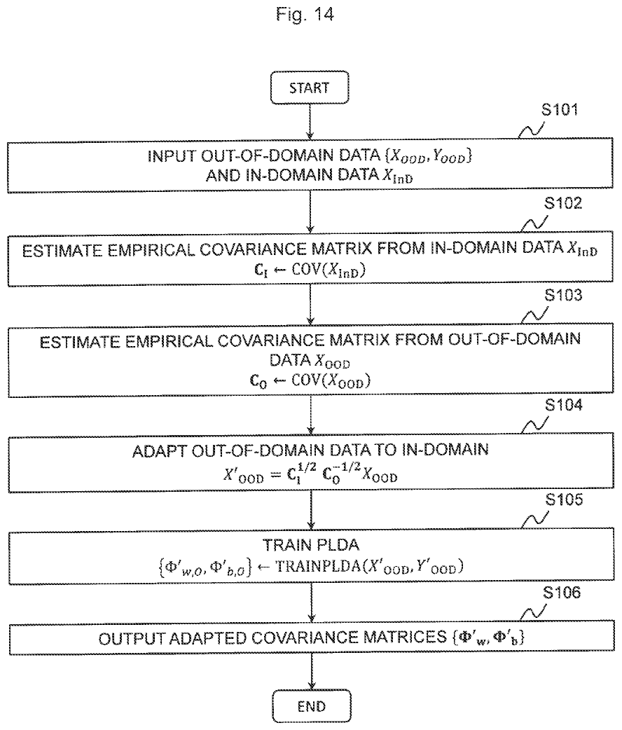

Next, an outline of the present invention will be described. FIG. 11 depicts a block diagram illustrating an outline of the unsupervised model adaptation apparatus according to the present invention. The unsupervised model adaptation apparatus 80 (for example, unsupervised model adaptation apparatus 100) according to the present invention includes: a covariance matrix computation unit 81 (for example, covariance matrix computation unit 31) which computes a pseudo-in-domain covariance matrix (for example, S) from one or both of a within class covariance matrix (for example, [Phi]_{w,0}) and a between class covariance matrix (for example, [Phi]_{b,0}) of an out-of-domain Probabilistic Linear Discriminant Analysis (PLDA) model, a simultaneous diagonalization unit 82 (for example, simultaneous dagonalization unit 32) which computes a generalized eigenvalue and an eigenvector (for example, {B, E}) for a pseudo-in-domain covariance matrix and the class covariance matrix of the out-of-domain PLDA model on the basis of simultaneous diagonalization, and an adaptation unit 83 (for example, adaptation unit 33) which computes one or both of a within class covariance matrix (for example, [Phi]⁺_{w}) and between class covariance matrix (for example, [Phi]⁺_{b}) of an in-domain PLDA model using the generalized eigenvalues and eigenvectors; wherein the covariance matrix computation unit 81 computes the pseudo-in-domain covariance matrix based on the out-of-domain PLDA model and a covariance matrix of in-domain data.

With such a configuration, when a model trained based on out-of-domain dataset is applied to an in-domain model using unsupervised data, it is possible to perform an unsupervised model adaptation while reducing the cost of adaptation.

In addition, the adaptation unit 83 may compute the pseudo-in-domain covariance matrix with an regularization process which avoids shrinking of the within and between class covariance matrices.

Specifically, the covariance matrix computation unit 81 may compute an out-of-domain covariance matrix based on the out-of-domain PLDA model, and compute the in-domain covariance matrix based on the out-of-domain covariance matrix, the covariance matrix of in-domain data, and the class covariance matrix.

In addition, the adaptation unit 83 may compute one or both of a within class covariance component and a between class covariance component of covariance components in a pseudo-in-domain HT-PLDA model.

Next, a configuration example of a computer according to the exemplary embodiment of the present invention will be described. FIG. 12 depicts a schematic block diagram illustrating the configuration example of the computer according to the exemplary embodiment of the present invention. The computer 1000 includes a CPU 1001, a main memory 1002, an auxiliary storage device 1003, an interface 1004, and a display device 1005.

The unsupervised model adaptation apparatus 100 described above may be installed on the computer 1000. In such a configuration, the operation of the apparatus may be stored in the auxiliary storage device 1003 in the form of a program. The CPU 1001 reads a program from the auxiliary storage device 1003 and loads the program into the main memory 1002, and performs a predetermined process in the exemplary embodiment according to the program.

The auxiliary storage device 1003 is an example of a non-transitory tangible medium. Another example of the non-transitory tangible medium includes a magnetic disk, a magneto optical disk, a CD-ROM, a DVD-ROM, a semiconductor memory or the like connected through the interface 1004. Furthermore, when this program is distributed to the computer 1000 through a communication line, the computer 1000 receiving the distributed program may load the program into the main memory 1002 to perform the predetermined process in the exemplary embodiment.

Furthermore, the program may partially achieve the predetermined process in the exemplary embodiment. Furthermore, the program may be a difference program combined with another program already stored in the auxiliary storage device 1003 to achieve the predetermined process in the exemplary embodiment.

Furthermore, depending on the content of a process according to an exemplary embodiment, some of elements of the computer 1000 can be omitted. For example, when information is not presented to the user, the display device 1005 can be omitted. Although not illustrated in FIG. 12, depending on the content of a process according to an exemplary embodiment, the computer 1000 may include an input device. For example, unsupervised model adaptation apparatus 100 may include an input device for inputting an instruction to move to a link, such as clicking a portion where a link is set.

In addition, some or all of the component elements of each device are implemented by a general-purpose or dedicated circuitry, a processor or the like, or a combination thereof. These may be constituted by a single chip or may be constituted by a plurality of chips connected via a bus. In addition, some or all of the component elements of each device may be achieved by a combination of the above circuitry or the like and a program.

When some or all of the component elements of each device is achieved by a plurality of information processing devices, circuitries, or the like, the plurality of information processing devices, circuitries, or the like may be arranged concentratedly or distributedly. For example, the information processing device, circuitry, or the like may be achieved in the form in which a client and server system, a cloud computing system, and the like are each connected via a communication network.

### REFERENCE SIGNS LIST

10 data input unit
20 training unit
30 model adaptation unit
31 covariance matrix computation unit
32 simultaneous dagonalization unit
33 adaptation unit
40 classifying unit
100 unsupervised model adaptation apparatus
200 unsupervised model adaptation apparatus
210 data input unit
220 training unit
230 component calculation unit
240 model adaptation unit
241 covariance matrix computation unit
242 simultaneous dagonalization unit
243 adaptation unit
250 parameter conversion unit
260 fitting unit
270 classifying unit

What is claimed is:

1. An unsupervised model adaptation apparatus comprising a hardware processor configured to execute a software code to:
compute a pseudo-in-domain covariance matrix from one or both of a within class covariance matrix and a between class covariance matrix of an out-of-domain Probabilistic Linear Discriminant Analysis (PLDA) model;
compute a generalized eigenvalue and an eigenvector for the pseudo-in-domain covariance matrix and a class covariance matrix of the out-of-domain PLDA model based on simultaneous diagonalization; and
compute one or both of a within class covariance matrix and a between class covariance matrix of an in-domain PLDA model using the generalized eigenvalues and eigenvectors,
wherein the hardware processor is configured to execute a software code to compute the pseudo-in-domain covariance matrix based on the out-of-domain PLDA model and a covariance matrix of in-domain data.

2. The unsupervised model adaptation apparatus according to claim 1,
wherein the hardware processor is configured to execute a software code to compute an in-domain covariance matrix with a regularization process which avoids shrinking of the within and between class covariance matrices.

3. The unsupervised model adaptation apparatus according to claim 1 or 2,
wherein the hardware processor is configured to execute a software code to compute an out-of-domain covariance matrix based on the out-of-domain PLDA model, and compute the pseudo-in-domain covariance matrix based on the out-of-domain covariance matrix, the covariance matrix of in-domain data, and the class covariance matrix.

4. The unsupervised model adaptation method according to claim 1,
wherein, the hardware processor is configured to execute a software code to compute one or both of a within class covariance component and a between class covariance component of covariance components in a pseudo-in-domain HT-PLDA model.

5. An unsupervised model adaptation method comprising:
computing a pseudo-in-domain covariance matrix from one or both of a within class covariance matrix and a between class covariance matrix of an out-of-domain Probabilistic Linear Discriminant Analysis (PLDA) model,
computing a generalized eigenvalue and an eigenvector for the pseudo-in-domain covariance matrix and a class covariance matrix of the out-of-domain PLDA model based on simultaneous diagonalization, and
computing one or both of a within class covariance matrix and a between class covariance matrix of an in-domain PLDA model using the generalized eigenvalues and eigenvectors;
wherein the pseudo-in-domain covariance matrix is computed based on the out-of-domain PLDA model and a covariance matrix of in-domain data.

6. The unsupervised model adaptation method according to claim 5,
wherein an in-domain covariance matrix is computed with a regularization process which avoids shrinking of the within and between class covariance matrix.

7. A non-transitory computer readable information recording medium storing an unsupervised model adaptation program, when executed by a processor, that performs a method for:
computing a pseudo-in-domain covariance matrix from one or both of a within class covariance matrix and a between class covariance matrix of an out-of-domain Probabilistic Linear Discriminant Analysis (PLDA) model;
computing a generalized eigenvalue and an eigenvector for the pseudo-in-domain covariance matrix and a class covariance matrix of the out-of-domain PLDA model based on simultaneous diagonalization; and
computing one or both of a within class covariance matrix and a between class covariance matrix of an in-domain PLDA model using the generalized eigenvalues and eigenvectors;
wherein the pseudo-in-domain covariance matrix is computed based on the out-of-domain PLDA model and a covariance matrix of in-domain data.

8. The non-transitory computer readable information recording medium according to claim 7, wherein an in-domain covariance matrix is computed with a regularization process which avoids shrinking of the within and between class covariance matrix.
